(19) United States
(12) Patent Application Publication
(10) Pub. No.: US 2016/0069380 A1
(43) Pub. Date: Mar. 10, 2016

(54) LOCKING MEMBER WITH DISPERSIVE ENERGY ABSORBENT LAYER

(71) Applicant: Alcoa Inc., Pittsburgh, PA (US)

(72) Inventors: Rodrigo Pinheiro, Riverside, CA (US); Gregory Rizza, Westminster, CA (US); Luke Haylock, Culver City, CA (US); Hasim Mulazimoglu, La Habra, CA (US); Michael March, Torrance, CA (US); Andreas Liebscher, San Diego, CA (US); Manish Kamal, Seal Beach, CA (US)

(73) Assignee: ALCOA INC., Pittsburgh, PA (US)

(21) Appl. No.: 14/847,326

(22) Filed: Sep. 8, 2015

Related U.S. Application Data
(60) Provisional application No. 62/048,015, filed on Sep. 9, 2014.

(51) Int. Cl. F16B 39/34

(52) U.S. Cl. CPC F16B 39/34

(57) ABSTRACT

A locking member includes a base portion having a first end, a second end opposite the first end, a bore extending from the first end to the second, the bore including a threaded portion having a plurality of internal threads, and an insert having a first end, a second end opposite the first end of the insert, a bore extending from the first end of the insert to the second end of the insert, the bore of the insert including a threaded portion having a plurality of internal threads. The insert is positioned within the bore of the nut. The insert is made from an electrically dispersive and electrically absorbent material, such as polymers, elastomers, flame retardant fabrics, metal foam, carbon foam, polymer foam or aerogel.

### CROSS-REFERENCE TO RELATED APPLICATION

This application is a Section 111(a) application relating to and claiming the benefit of commonly-owned, co-pending U.S. Provisional Patent Application Ser. No. 62/048,015, entitled “NUT/COLLAR WITH DISPERSIVE ENERGY ABSORBENT LAYER,” filed Sep. 9, 2014, the entirety of which is incorporated herein by reference.

### FIELD OF THE INVENTION

The present invention relates to fasteners and, more particularly, to fastener locking members, such as nuts and collars, for lightning strike protection.

### BACKGROUND OF THE INVENTION

Continuous fiber reinforced composites are extensively used in both primary and secondary aircraft components for a variety of applications where light weight, higher strength and corrosion resistance are primary concerns. Composites are typically composed of fine carbon fibers that are oriented at certain directions and surrounded in a supportive polymer matrix. Since the plies of the composite material are arranged at a variety of angles, and depending upon the direction of major loading, the resultant structure is typically a stacked laminated structure, which is highly anisotropic and heterogeneous. A significant portion of the composite structure is fabricated as near net-shape, but is drilled in order to facilitate joining of components using mechanical fasteners. Drilling fastener holes in composite does not compare to the uniformity of aluminum or steel since individual carbon fibers fracture at irregular angles and form microscopic voids between the fastener and the hole. As the cutting tool wears down, there is an increase of surface chipping and an increase in the amount of uncut fibers or resin and delamination. The composite microstructure containing such defects is referred to as “machining-induced micro texture.”

In addition to their machining challenges, composite structures in aircrafts are more susceptible to lightning damage compared to metallic structures. Metallic materials, such as aluminum, are very conductive and are able to dissipate the high currents resulting from a lightning strike. Carbon fibers are 100 times more resistive than aluminum to the flow of current. Similarly epoxy, which is often used as a matrix in conjunction with carbon fibers, is 1 million times more resistive than aluminum. The composite structural sections of an aircraft often behave like anisotropic electrical conductors. Consequently, lightning protection of a composite structure is more complex, due to the intrinsic high resistance of carbon fibers and epoxy, the multi-layer construction, and the anisotropic nature of the structure. Some estimates indicate that, on average, each commercial aircraft in service is struck by lightning at least once per year. Aircraft flying in and around thunderstorms are often subjected to direct lightning strikes as well as to nearby lightning strikes, which may produce corona and streamer formations on the aircraft. In such cases, the lightning discharge typically originates at the aircraft and extends outward from the aircraft. While the discharge is occurring, the point of attachment moves from the nose of the aircraft and into the various panels that compromise the skin of the aircraft. The discharge usually leaves the aircraft structure through the empennage.

The protection of aircraft fuel systems against fuel vapor ignition due to lightning is even more critical. Since commercial aircraft contain relatively large amounts of fuel and also include very sensitive electronic equipment, they are required to comply with a specific set of requirements related to the lightning strike protection in order to be certified for operation. It is a well-known fact that fasteners are often the primary pathways for the conduction of the lightning currents from skin of the aircraft to supporting structures such as spars or ribs, and poor electrical contact between the fastener body and the parts of the structure can lead to detrimental fastener arcing or sparking.

In the event of a lightning strike to an aircraft, several strategies are employed to mitigate the possibility of sparking occurring around fasteners. To avoid the potential for ignition of fuel at the fastener composite structure interface by a lightning strike, one of these strategies involves the containment of sparking material (hot gases and particles caused by the creation of plasma during a lightning strike) that might be ejected from fastener holes, on the nut/collar side.

### SUMMARY OF THE INVENTION

In an embodiment, a nut/collar having a counterbore and an insert fitted within the counterbore. In an embodiment, the nut/collar has a ring shape. In an embodiment, the insert is made of a dispersive and energy absorbent material. In an embodiment, the insert is fitted or deposited within the nut/collar counterbore and develops an interference fit condition with a shank of a mating pin during fastener installation, as well as intimate contact with the bearing surface of the fastened material (e.g., skin, spars, ribs, etc.). In an embodiment, the insert is made from a variety of naturally dispersive and energy absorbent materials, depending on the desired properties required for specific strike containment. In an embodiment, the insert is made from polymers or elastomers for their energy absorption characteristics during deformation, their sealing capabilities, and the isolation provided because of their low electrical conductivity. In an embodiment, the insert is made from flame retardant fabrics due to their high temperature endurance. In an embodiment, the insert is made from cellular and crushable materials, such as metal, carbon or polymer foams, for their energy absorption through crushing failure, and ability to vary and grade electrical conductivity between the fastener and fastened material. In an embodiment, the insert is made from an aerogel product, due to its ability to handle high temperature loads and its ability to collect plasma particles.

### BRIEF DESCRIPTION OF THE DRAWINGS

FIG. 1 is a side cross-sectional view of a locking member (nut/collar) with a tapped insert in accordance with an embodiment;

FIG. 2 is a side cross-sectional view of the locking member shown in FIG. 1 with a pin member engaged;

FIG. 3 is a side cross-sectional view of another embodiment of a locking member having an enlarged counterbore with an insert and a pin member inserted therein;

FIG. 4A is a top perspective view of a polymer insert, while FIG. 4B is a photograph of a nut including the polymer insert shown in FIG. 4A;

FIG. 5A is a top perspective view of a carbon insert, while FIG. 5B is a photograph of a nut including the carbon insert shown in FIG. 5A; and

FIG. 6A is a top perspective view of an aerogel insert, while FIG. 6B is a photograph of a nut including the aerogel insert shown in FIG. 6A.

### DETAILED DESCRIPTION OF THE DRAWINGS

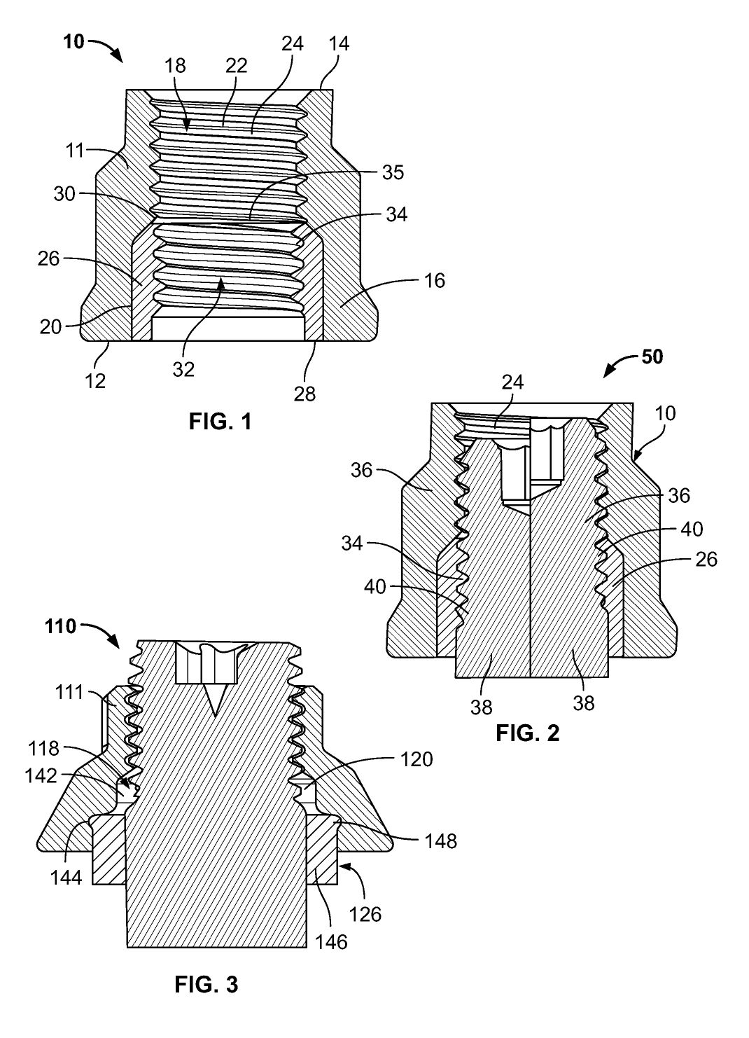

FIG. 1 shows an embodiment of a locking member 10. In an embodiment, the locking member 10 includes a nut. In another embodiment, the locking member 10 includes a collar. In an embodiment, the locking member 10 includes a base portion 11 having a first end 12, a second end 14 opposite the first end 12, and a flanged portion 16 located at the first end 12. In an embodiment, the base portion 11 is a nut. In another embodiment, the base portion 11 is a collar. In an embodiment, a bore 18 extends from the first end 12 to the second end 14. In an embodiment, the bore 18 includes a cavity 20 located proximate to the first end 12, and a threaded portion 22 located proximate to the second end 14 and having a plurality of internal threads 24. In an embodiment, the locking member 10 includes an insert 26 fitted within the cavity 20 of the base portion 11. In an embodiment, the insert 26 is substantially cylindrical in shape. In an embodiment, the insert 26 has a ring shape. In an embodiment, the insert 26 includes a first end 28, a second end 30, and a bore 32 extending from the first end 28 to the second end 30. In an embodiment, the bore 32 is tapped and includes a plurality of internal threads 34. In an embodiment, the threads 34 of the insert 26 dovetail with the threads 24 of the locking member 10 at a location 35 to form a continuous threaded portion. In an embodiment, the cavity 20 and the insert 26 are sized and shaped so that the insert 26 is secured within the cavity 20 by a frictional fit. In other embodiments, the insert 26 is secured within the cavity 20 by attachment using an epoxy medium, injected and adhered to the cavity 20 during a curing process, or through some particle deposition where the insert 26 is created using a deposition process in the cavity 20 and then cured.

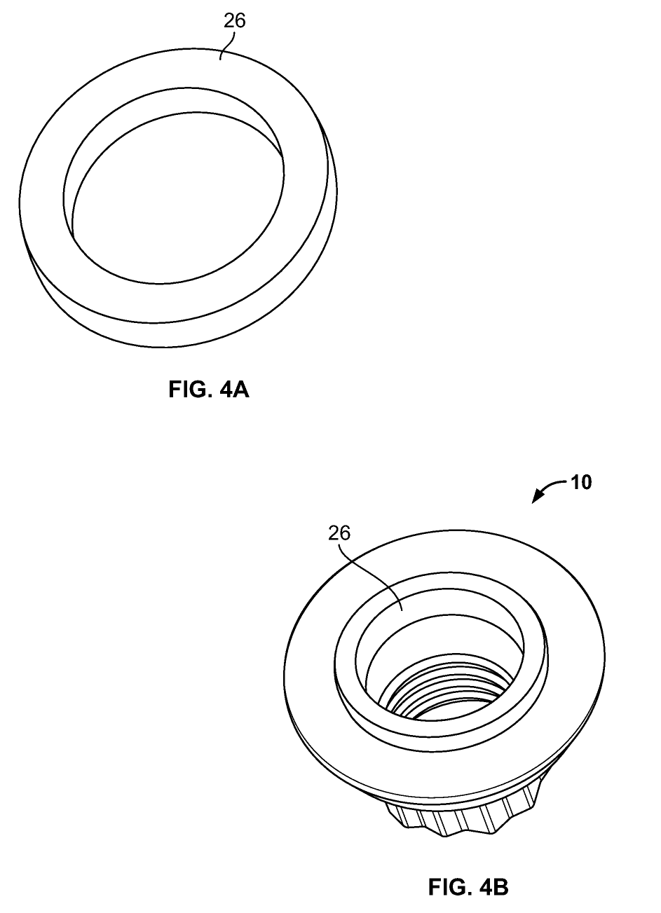

In an embodiment, the insert 26 is made of an electrically dispersive material and/or an electrical energy absorbent material. In an embodiment, the insert 26 is made from a polymer. In another embodiment, the insert 26 is made from an elastomer. In an embodiment, the polymer or elastomer insert 26 is created through injection molding, additive manufacturing, or machining operations starting from a rod of the material and processed to the desired shape. FIGS. 4A and 4B show an embodiment of a polymer insert 26 and the insert 26 fitted within the locking member 10, respectively.

In another embodiment, the insert 26 is made from a flame retardant fabric. In an embodiment, the fabric insert 26 is made from a fabric sheet having a desired thickness and is machined to achieve a desired shape.

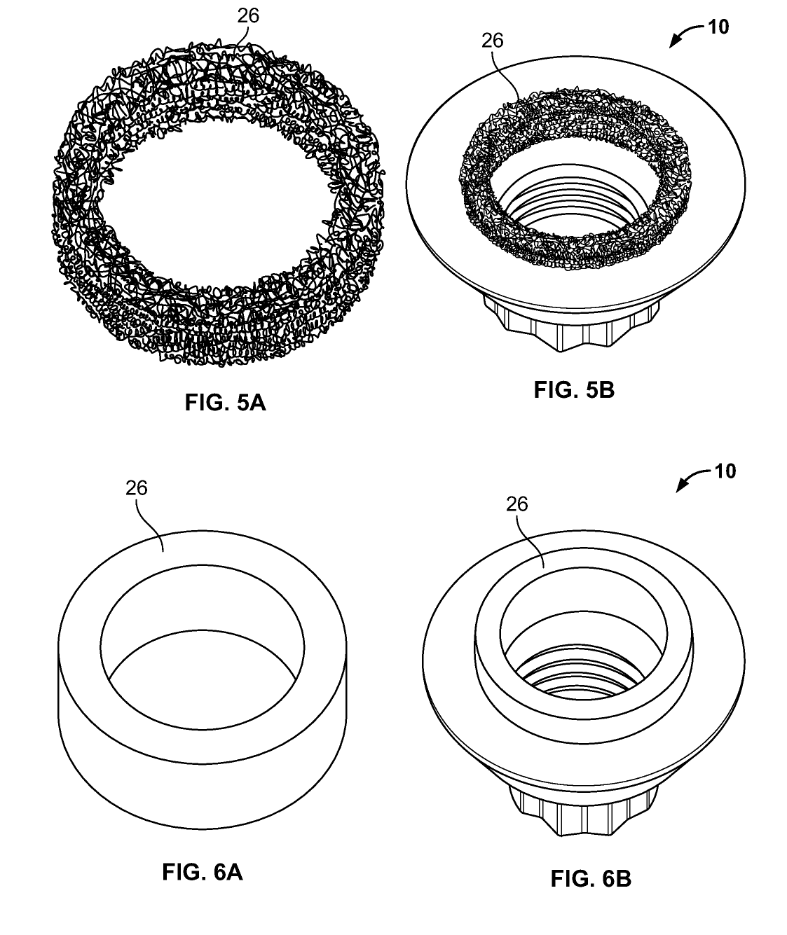

In another embodiment, the insert 26 is made from cellular and crushable material, such as metal, carbon or polymer foams. In an embodiment, for the cellular and crushable material insert 26, once the material has been chosen (e.g., metal, carbon or polymer), the desired density and pores per inch (PPI) of the material must be decided for the application. Once material and composition are determined, the insert 26 can be made through casting, dispersion, or can be machined from raw foam stock using varying machining methods depending of classification of the material. FIGS. 5A and 5B show an embodiment of a carbon foam insert 26 and the insert 26 fitted within the base portion 11, respectively.

In another embodiment, the insert 26 is made from an aerogel product. In an embodiment, for the aerogel insert 26, depending on the base material used in creating the aerogel, the insert 26 can be created through casting, dispersion, or machined from raw aerogel stock. FIGS. 6A and 6B show an embodiment of an aerogel insert 26 and the insert 26 fitted within the base portion 11, respectively.

In an embodiment, as part of a fastener, the locking member 10 is adapted to engage a pin member or a bolt in order to secure a plurality of work pieces to one another, and is adapted to be installed within aligned holes in such work pieces (not shown in the Figures). In an embodiment, the work pieces are formed of a composite material. In an embodiment, and except as noted herein, the fastener has a structure and function that are, or are similar to, the structure and function of the fasteners disclosed in U.S. Pat. No. 7,695,226 to March et al, the entirety of which is incorporated by reference herein.

Referring to FIG. 2, in an embodiment, a fastener 50 including the locking member 10 is shown engaged with a pin member 36 during fastener installation. In FIG. 2, the pin member 36 is shown broken into two half-views; the left side view showing partial installation of the locking member 10 on the pin member 36, and the right side view showing a further partial installation of the locking member 10 on the pin member 36. In an embodiment, the pin member 36 includes a shank 38 having a plurality of external threads 40 that engage threadedly the threads 34 of the insert 26 and the threads 24 of the locking member 10. In an embodiment, the insert 26 develops an interference fit condition with the shank 38 of the pin member 36 during the fastener installation, as well as intimate contact with the bearing surface of the fastened structure.

FIG. 3 shows another embodiment of a locking member 110. The locking member 110 has a structure and function similar to those of the locking member 10 except as noted hereinafter. In an embodiment, the locking member 110 includes a base portion 111 having a bore 118 with a cavity 120, which includes an enlarged counterbore 142 having an internal annular portion 144. In an embodiment, an insert 126 includes a tubular portion 146 and a flanged portion 148 that engages the internal annular portion 144 of the counterbore 142.

In the event of a lightning strike, if sparking happens within the fastener 50, and hot gases and particles are ejected from the fastener hole, this insert 26 provides a deformable barrier that damps the spark material, trapping the particles and cooling the gases, preventing them to escape to the outside of the locking member 10. Also, the choice of electrical conductivity of the insert 26 will allow for desired electrical flow criteria to be met during the case of a lightning strike to the fastener assembly.

It should be understood that the embodiments described herein are merely exemplary and that a person skilled in the art may make many variations and modifications without departing from the spirit and scope of the invention. All such variations and modifications are intended to be included within the scope of the invention.

What is claimed is:

1. A locking member, comprising:
a base portion having a first end, a second end opposite the first end, a bore extending from the first end to the second, the bore including a threaded portion having a plurality of internal threads; and
an insert having a first end, a second end opposite the first end of the insert, a bore extending from the first end of the insert to the second end of the insert, the bore of the insert including a threaded portion having a plurality of internal threads,
wherein the insert is positioned within the bore of the nut, and
wherein the insert is made from an electrically dispersive and electrically absorbent material.

2. The locking member of claim 1, wherein the insert is made of an elastomer.

3. The locking member of claim 1, wherein the insert is made of a polymer.

4. The locking member of claim 1, wherein the insert is made of a flame retardant fabric.

5. The locking member of claim 1, the insert is made of a cellular and crushable material.

6. The locking member of claim 1, wherein the cellular and crushable materials is selected from the group consisting of metal foam, carbon foam, and polymer foam.

7. The locking member of claim 1, wherein the insert is made from aerogel.

8. The locking member of claim 1, wherein the base portion is a nut.

9. The locking member of claim 1, wherein the base portion is a collar.

10. A fastener, comprising:
a pin member having an elongated shank portion and a threaded portion with a plurality of external threads; and
a locking member including a base portion having a first end, a second end opposite the first end, a bore extending from the first end to the second, the bore including a threaded portion having a plurality of internal threads, and an insert having a first end, a second end opposite the first end of the insert, a bore extending from the first end of the insert to the second end of the insert, the bore of the insert including a threaded portion having a plurality of internal threads, wherein the insert is positioned within the bore of the nut, and wherein the insert is made from an electrically dispersive and electrically absorbent material,
wherein the plurality of external threads of the threaded portion of the pin member is adapted to engage threadedly the plurality of internal threads of the threaded portion of the base portion and the plurality of internal threads of the insert.

11. The fastener of claim 10, wherein the insert is made of an elastomer.

12. The fastener of claim 10, wherein the insert is made of a polymer.

13. The fastener of claim 10, wherein the insert is made of a flame retardant fabric.

14. The fastener of claim 10, the insert is made of a cellular and crushable material.

15. The fastener of claim 10, wherein the cellular and crushable materials is selected from the group consisting of metal foam, carbon foam, and polymer foam.

16. The fastener of claim 10, wherein the insert is made from aerogel.

17. The fastener of claim 10, wherein the base portion is a nut.

18. The fastener of claim 10, wherein the base portion is a collar.

19. The fastener of claim 10, wherein the insert forms an interference fit with the elongated shank portion of the pin member when the locking member is installed on the pin member.
